(19) United States
(12) Patent Application Publication
(10) Pub. No.: US 2019/0245934 A1
(43) Pub. Date: Aug. 8, 2019

(54) SOCIAL CONTENT ENDORSEMENT

(71) Applicant: Google Inc., Mountain View, CA (US)

(72) Inventors: David Young CHUNG, Palo Alto, CA (US); Laura PARAGANO, San Francisco, CA (US)

(21) Appl. No.: 14/688,991

(22) Filed: Apr. 16, 2015

Related U.S. Application Data
(60) Provisional application No. 62/045,481, filed on Sep. 3, 2014.

(51) Int. Cl. H04L 29/08; H04L 29/06

(52) U.S. Cl. CPC H04L 67/22; H04L 67/42

(57) ABSTRACT

Techniques for social content endorsement are provided. An example method includes receiving content for display in a content area, the content area associated with an account linked to a first social network, automatically determining one or more social endorsement types to allow endorsement of the content, the endorsement types determined based on one or more of: a second social network originally associated with the content or one or more other social networks linked to the account, providing, for display in the content area, the one or more determined social endorsement types with the content, and when a selection to endorse the content via the displayed one or more determined social endorsement types is received, endorsing the content based on one or more selected social endorsement types at their respective social networks.

### RELATED APPLICATION

This application claims the benefit of U.S. Provisional Patent Application No. 62/045,481, filed on Sep. 3, 2014, and titled “Social Content Endorsement”, which is herein incorporated in its entirety by reference.

### BACKGROUND

The present disclosure relates generally to content and particularly to endorsement of such content. Users are increasingly sharing and endorsing content, such as videos, images, posts and other content.

### SUMMARY

The disclosed subject matter relates to social content endorsement.

In some innovative implementations, the disclosed subject matter can be embodied in a method. The method comprises receiving content for display in a content area, the content area associated with an account linked to a first social network, automatically determining one or more social endorsement types to allow endorsement of the content, the endorsement types determined based on one or more of: a second social network originally associated with the content or one or more other social networks linked to the account, providing, for display in the content area, the one or more determined social endorsement types with the content, and when a selection to endorse the content via the displayed one or more determined social endorsement types is received, endorsing the content based on one or more selected social endorsement types at their respective social networks.

In some innovative implementations, the disclosed subject matter can be embodied in a machine readable medium. The machine readable medium includes instructions, which when executed by a processor, cause the processor to perform operations receive content for display in an application, the application associated with an account linked to a first social network, display in the application with the content, one or more social endorsement types to allow endorsement of the content, the endorsement types automatically determined based on one or more of: a second social network originally associated with the content or one or more other social networks linked to the account, when one or more selections to endorse the content via the displayed one or more social endorsement types are received, provide one or more endorsements based on one or more selected social endorsement types to their respective social networks.

In some innovative implementations, the disclosed subject matter can be embodied in a system. The system comprises a memory comprising instructions and a processor configured to execute the instructions to receive content for display in an application, the application associated with an account linked to a first social network, display in the application with the content, one or more social endorsement types to allow endorsement of the content, the endorsement types automatically determined based on one or more of: a second social network originally associated with the content or one or more other social networks linked to the account, when one or more selections to endorse the content via the displayed one or more social endorsement types are received, provide one or more endorsements based on one or more selected social endorsement types to their respective social networks.

It is understood that other configurations of the subject technology will become readily apparent to those skilled in the art from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The novel features of the subject technology are set forth in the appended claims. However, for purpose of explanation, several configurations of the subject technology are set forth in the accompanying figures summarized below.

FIG. 1A is a diagram of an example device and network environment suitable for practicing some implementations of the subject technology.

FIG. 1B is a diagram of an example user interface suitable for practicing some implementations of the subject technology.

FIG. 2 is an example process for practicing implementations of the subject technology using the example device of FIG. 1A.

FIG. 3 illustrates another example process for practicing implementations of the subject technology using the example device of FIG. 1A.

FIG. 4 illustrates yet another example process for practicing implementations of the subject technology using the example device of FIG. 1A.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The subject technology is not limited to the specific details set forth herein and may be practiced without these specific details.

Users may use different social networks to share and endorse content These social networks can have their own endorsement types or models. As a result, users may need to navigate away (e.g., open a separate application or website) from one social network to engage with content posted on another social network. This can create a disjointed social experience that can lack fluidity and may force a user away from their preferred social network. In some cases, content created or originally shared on a first social network may be embedded in content associated with a second social network. However, while users may embed or share content on the second social network, they may be limited to endorsing the content based on the endorsement model of the second social network instead of another social endorsement model associated with the first social network or a different social network. This may degrade a user's social networking experience especially when the user may prefer a social network different from the second social network. In addition, an original creator or publisher of the content may receive endorsements on the second social network instead of (or in addition to) the first social network where the creator initially anticipated receiving endorsements.

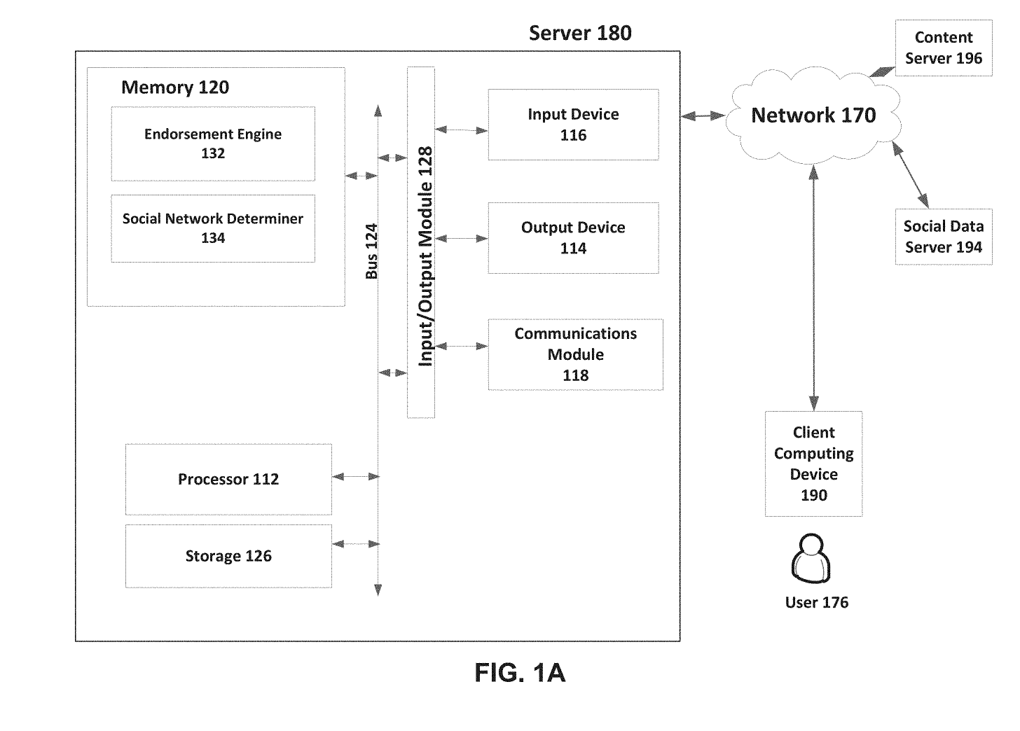

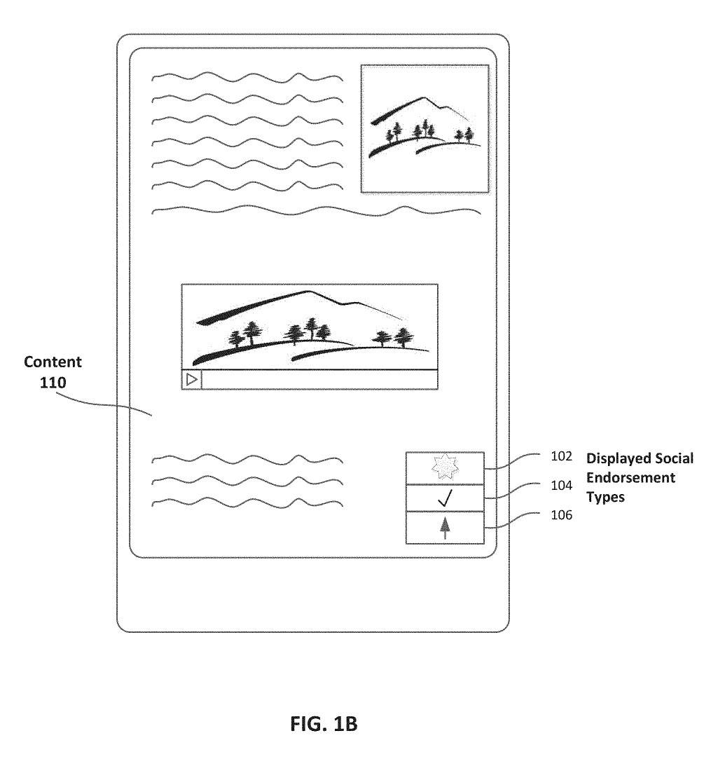

The disclosed implementations include receiving content for display in a content area. The content area can be associated with an account linked to a first social network. For example, a video may be received at a browser tab, mobile or application that is presently associated with an account linked to a first social network. The browser tab or application may be associated with the account linked to a first social network because a user may have logged into the first social network after providing valid credentials via the browser tab or application. The video may have been originally published on a second social network. The disclosed implementations may automatically determine one or more social endorsement types to allow endorsement of the content. The endorsement types can be determined based on one or more of: the second social network originally associated with the content or one or more other social networks linked to the account. The one or more determined social endorsement types can be provided for display with the content in the same content area (e.g., browser tab) or application that is associated with the account linked to the first social network. FIG. 1B illustrates an example user interface including content 110 and different displayed social endorsement types 102, 104 and 106. The social endorsement types may be associated with their respective social networks. The social endorsement types may have their respective icons that allow a user to associate the social endorsement types with their respective social networks. It is to be appreciated that the icons displayed in FIG. 1B are illustrative and are not intended to limit the disclosed implementations. When a selection to endorse content 110 via the displayed one or more determined social endorsement types 102, 104 and 106 may be received, content 110 can be endorsed based on one or more selected social endorsement types at their respective social networks.

In this way, a user need not navigate away from the first social network (e.g., open a separate application, website or browser tab) to endorse the content on a different second social network. The user may conveniently endorse the content via the user's preferred social network or even on the second social network where the content may have been originally published. This provides a seamless social experience for the user and enhances user experience. In addition, an original creator or publisher of the content may receive endorsements on the second social network where the creator initially anticipated receiving endorsements instead of (or in addition to) the first social network.

Some aspects of the subject technology include storing information regarding user accounts and social networks. A user has the option of preventing storage of such information. The user may also be provided with an opportunity to control whether programs or features collect or share user information (e.g., information about the user's social networking accounts, the user's preferences, etc.). Thus, the user may have control over how information is collected about the user and used by a server.

FIG. 1A is a diagram illustrating example architecture for social content endorsement according to some implementations of the subject technology. Server 180 includes processor 112, memory 120, storage 126, bus 124, input/output module 128, input device 116, output device 114 and communications module 118. Memory 120 includes endorsement engine 132 and social network determiner 134. In some implementations, server 180 includes one or more modules for facilitating user interaction via a browser, application, mobile application or a special purpose application executing on client computing device 190 for processing data stored in social data server 194. Server 180 may be implemented as a single machine with a single processor, a multi-processor machine, or a server farm including multiple machines with multiple processors. Communication module 118 can enable server 180 to send and receive data over network 150 to social data server 194, content server 196 and client computing device 190.

In some implementations, content server 196 can include data including but not limited to video, audio, text, images or any combination thereof. The data stored at content server 196 may be provided for display in browser tabs, applications or any other content areas. For example, a video stored at the content server 196 may be streamed to an application (e.g., mobile application) or browser tab for display to user 176 via client computing device 190. In another example, audio stored at content server 196 may be streamed to the application or browser tab for playback to user 176 via client computing device 190. In yet another example, a social media post stored at content server 196 may be provided to the application or browser tab for engagement by user 176 via client computing device 190.

In some implementations, server 180 can be associated with social data server 194 that includes social data and may send and receive data over network 150 to the social data server 194. In some implementations, social data server 194 may store social content item(s) (e.g., posted content item(s)) associated with a social networking service. Social data server 194 may also store data related to user accounts and content items that are associated with the user accounts. For example, social data server 194 can include data indicating content items that have been viewed, shared, commented on or endorsed (e.g., favored or disfavored) by a user account associated with a user. Social data server 194 may also store information identifying different social networking services that are associated with a user account (e.g., an account of user 176). Social data server 194 may also store information identifying a preferred social networking service associated with the user account. In some implementations, social data server 194 may also store authentication data (e.g., a username and password) associated with one or more social networking services associated with the user account. Social data server 194 may also store open authentication information that provides client applications executing on client computing device 190 access to server 180's or content server 196's resources on behalf of a resource owner. Open authentication information may specify a process for resource owners to authorize third-party access to their server resources without sharing their credentials. Open authentication may allow access tokens to be issued to third-party clients by a server (e.g., server 180), with the approval of the resource owner, or end-user. The client (e.g., client computing device 190) may then use an access token to access protected resources hosted by the resource server. Open authentication allows content surfers to log into third-party sites using their different social networking accounts. Social data server 194 may store a social connection data structure that is indicative of social connections between user accounts associated with the social networking service. Social data server 194 may also store user comments made (or annotations) towards content consumed by the user and stored at content server 196.

In some implementations, content server 196, social data server 194, client computing device 190 and server 180 can communicate with one another via network 150. Network 150 may include the Internet, an intranet, a local area network, a wide area network, a wired network, a wireless network, or a virtual private network (VPN). While only one content server 196, social data server 194, client computing device 190 and server 180 are illustrated, the subject technology may be implemented in conjunction with any number of content servers 196, social data servers 194, client computing device 190 and servers 180. In some non-limiting implementations, a single computing device may implement the functions of content server 196, social data server 194 and server 180 and other components illustrated in FIG. 1A. It is to be appreciated that the disclosed limitations are not limited to web-based content and applications and can operate with any type of content and applications, including, but not limited to, mobile device applications and content.

Client computing device 190 can be a laptop computer, a desktop computer, a mobile phone, a personal digital assistant (PDA), a tablet computer, a netbook, a television with one or more processors embedded therein or coupled thereto, a physical machine, or a virtual machine. Client computing device 190 may include one or more of a keyboard, a mouse, a display, or a touch screen. Client computing device 190 can include a browser or any application configured to display pages or any content. For example, the browser can display a page including multimedia content from content server 196. Alternatively, client computing device 190 may include special-purpose applications (e.g., mobile phone or tablet computer applications) for accessing and displaying content.

As discussed above, memory 120 of server 180 can include endorsement engine 132 and social network determiner 134. In some implementations, server 180 may receive content for display in a content area. The content may be received at server 180 from content server 196 when the content is requested at client computing device 190. For example, content may be requested from content server 196 via a content area (e.g., browser tab) of a browser or application executing at client computing device 190. Content server 196 may be configured to provide the content to server 180 that processes the content in accordance with the disclosed implementations. Server 180 may then provide the content in accordance with the disclosed implementations to client computing device 190. In this way, server 180 may act as a proxy server between content server 196 and client computing device 190. In another example, content may be requested from server 180 by a browser or application executing at client computing device 190. Server 180 may provide the request to content server 196. Content server 196 may then provide the content in accordance with the disclosed implementations to client computing device 190. In some implementations, content may be requested from content server 196 by a browser or application executing at client computing device 190. Content server 196 may then provide the content in accordance with the disclosed implementations to client computing device 190.

In some implementations, a content area or application from where a content request is made (or where content is received or pushed) can be associated with an account linked to a first social network. The content area (e.g., browser tab) may be associated with the account linked to the first social network when user 176 signs into the account via the content area. Similarly, an application may be associated with the account linked to the first social network when user 176 signs into the application. The first social network may be associated with a first social endorsement type that may be represented via a first icon in association with the content. A social endorsement type may be displayed on an interface with content (e.g., displayed endorsement type 102) and can act as an interface between a user and a social network. The social endorsement type can allow a user to log, into the social network, the user's sentiment with respect to content. For example, social endorsement type may allow favoring, disfavoring, up-voting, down-voting, etc. of the content or any combination thereof. A video may be received from content server 196 at a browser tab or any content area at client computing device 190 that is presently associated with the account linked to a first social network. The video may have been originally published on a second social network. The second social network may be associated with a second social endorsement type (or model) that may be represented via a second icon in association with the content. For example, the video may be published on the second social network by a user who may be different from user 176 using a different computing device. As a non-limiting example, the first social network may be a video sharing network and the second social network may be a micro-messaging network. This example is illustrative and is not intended to limit the disclosed implementations.

In some implementations, endorsement engine 132 may automatically determine one or more social endorsement types to allow endorsement of the content. The endorsement types can be determined based on one or more of: the second social network originally associated with the content or one or more other social networks linked to the account (e.g. account of user 176). For example, log-in credentials associated with a user account may also be shared or associated with other social networks. In some implementations, endorsement engine 132 may determine one or more social networks associated with the account by reading authentication information (e.g., open authentication information) stored at social data server 194. For example, endorsement engine 132 may provide an account identifier (e.g., username) to the social data server 194 and may receive from the social data server one or more social networking accounts associated or linked with the account information. The account information may itself be credentials to access a particular social network. In some implementations, endorsement engine 132 may automatically determine one or more social endorsement types based on parsing markup language associated with the content. For example, the markup language may include an identification of a social network (e.g., the second social network) where the content was originally published. The original publisher of the content may be able to modify the markup language associated with the content to indicate a particular social network where endorsements are to be provided even when the a user consuming the content provides an endorsement of the content via a different social network.

In some implementations, the one or more determined social endorsement types can be provided for display with the content in the same content area that is associated with the account linked to the first social network. In this way, for example, even when the content is displayed at an application at client computing device 190 that is presently associated with an account linked to a first social network, endorsement engine 132 may automatically determine that second social endorsement type may need to be displayed with the content because the content was originally associated (e.g., published) with the second social network or even a different social network indicated by an original publisher of the content.

In some implementations, in addition to determining the second endorsement type associated with the second social network, endorsement engine 132 may determine other endorsement types (e.g., a third, a fourth and a fifth endorsement type) associated with the account linked to the social network. For example, the account associated with the first social network may share the same authentication information (e.g., username and password) with other social networks. In some implementations, social network determiner 134 may determine the other social networks because they may share the same authentication information or authentication tokens. For example, if two different social networking accounts share the same authentication information or tokens, they may be determined by social network determiner 134 to be linked to same account.

In some implementations, the one or more social endorsement types may be provided for display from server 180 at client computing device 190. As a non-limiting example, the one or more social endorsement types may be displayed in an interactive widget or any other form of user interface at client computing device 190. When a selection to endorse the content via the displayed one or more determined social endorsement types may be received, the content can be endorsed by endorsement engine 132 based on one or more selected social endorsement types at their respective social networks determined by social network determiner 134. As a non-limiting example, when an endorsement via a first social endorsement type is received at client computing device 190 (e.g., via a user interface), the endorsement is provided by the client computing device 190 to server 180. In some implementations, social network determiner 134 at server 180 may determine the social endorsement types associated with the respective social networks based on a database of known social networks and respective endorsement types stored at server 180. For example, the database may include one or more rows and columns including names (or identifiers) or social networks and their respective endorsement types.

In this way, a user need not navigate away from the first social network (e.g., open a separate application, website or browser tab) to endorse the content on a different second social network. The user may conveniently endorse the content via the user's preferred social network or even on the second social network where the content may have been originally published. This provides a seamless social experience for the user and enhances user experience. In addition, an original creator or publisher of the content may receive endorsements on the first social network where the creator initially anticipated receiving endorsements instead of (or in addition to) the second social network. For example, if the user provides an endorsement through the second social network at client computing device 190, and social network determiner 134 may determine that the content is to be endorsed on the first social network based on markup language of the content or one or more instructions included in the markup language. The instructions may be previously embedded in the markup language of the content by the creator of the content and may instruct social network determiner 134 to automatically endorse the content at the first social network. Social network determiner 134 may automatically endorse the content at the first social network based on the instructions.

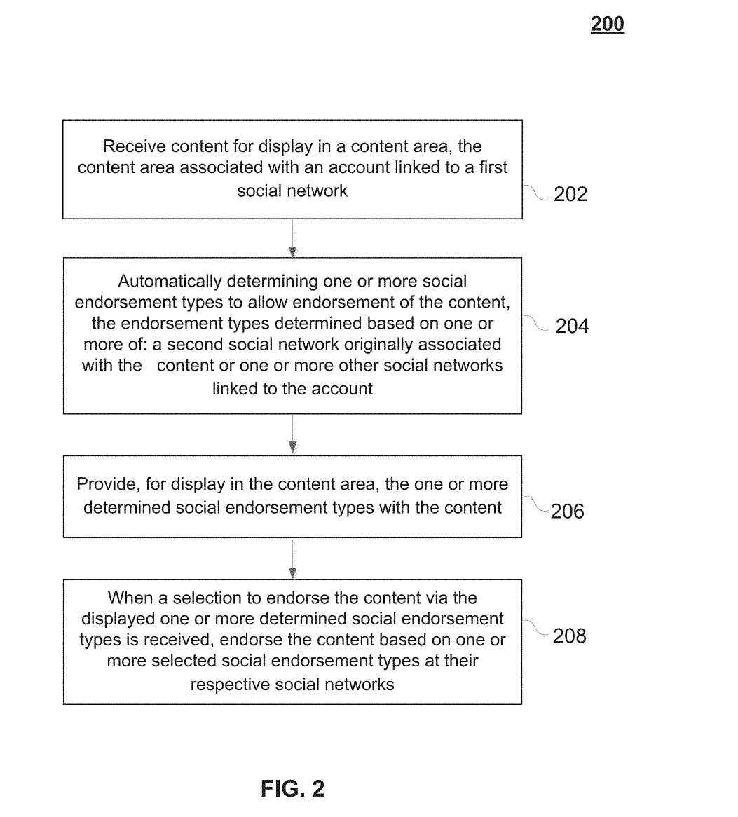

FIG. 2 is an example process 200 for practicing implementations of the subject technology using the example architecture of FIG. 1A. Although FIG. 2 is described with reference to the elements of FIG. 1A, the process of FIG. 2 is not limited to such and can be applied within other systems.

Process 200 begins with receiving content for display in a content area, the content area associated with an account linked to a first social network (block 202). For example, server 180 may receive content for display in a content area. The content may be received at server 180 from content server 196 when the content is requested at client computing device 190. For example, content may be requested from content server 196 via a content area (e.g., browser tab) of a browser or application executing at client computing device 190. Content server 196 may provide the content to server 180 that processes the content in accordance with the disclosed implementations. In this way, server 180 may act as a proxy server between content server 196 and client computing device 190. A content area or application from where a content request is made (or where content is received or pushed) can be, for example, associated with an account linked to a first social network. The content area may be associated with the account linked to the first social network when user 176 signs into the account via the content area. Similarly, an application may be associated with the account linked to the first social network when user 176 signs into the application via the application. The first social network may be associated with a first social endorsement type (or model) that may be represented via a first icon in association with the content.

Process 200 proceeds by automatically determining one or more social endorsement types to allow endorsement of the content, where the endorsement types can be determined based on one or more of: a second social network originally associated with the content or one or more other social networks linked to the account (block 204). As an example, social network determiner 134 may automatically determine one or more social endorsement types to allow endorsement of the content. The endorsement types can be determined based on one or more of: the second social network originally associated with the content or one or more other social networks linked to the account (e.g., account of user 176). For example, log-in credentials associated with a user account may also be shared or associated with other social networks. In some implementations, social network determiner 134 may determine the other social networks because they may share the same authentication information or authentication tokens. For example, if two different social networking accounts share the same authentication information or tokens, they may be determined by social network determiner 134 to be linked to same account.

The one or more determined social endorsement types can be provided for display in the content area with the content (block 206). For example, endorsement engine 132 may provide one or more determined social endorsement types for display in the content area with the content. In this way, for example, even when the content is displayed at an application at client computing device 190 that is presently associated with an account linked to a first social network, endorsement engine 132 may automatically determine that second social endorsement type may need to be displayed with the content because the content was originally associated (e.g., published) with the second social network. When a selection to endorse the content via the displayed one or more determined social endorsement types is received, the content may be endorsed based on one or more selected social endorsement types at their respective social networks (block 208). For example, the one or more determined social endorsement types may be displayed via respective icons on a user interface associated with the content. The display may be in the form of a widget, menu, pop-up or any other user interaction element.

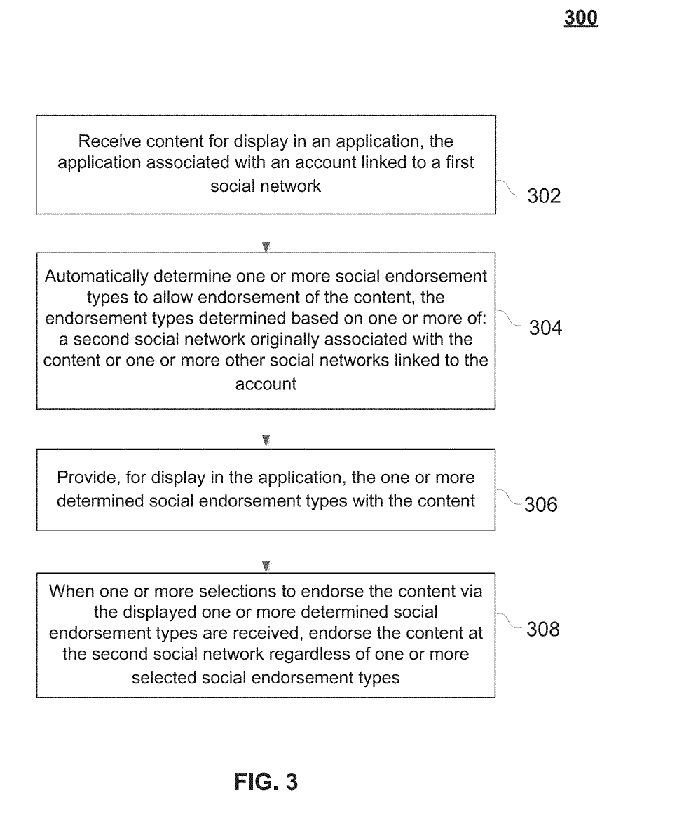

FIG. 3 is an example process 300 for practicing implementations of the subject technology using the example device of FIG. 1A. Although FIG. 3 is described with reference to the elements of FIG. 1A, the process of FIG. 3 is not limited to such and can be applied within other systems. Process 300 begins with receiving content for display in an application, the application associated with an account linked to a first social network (block 302). For example, server 180 may receive content for display in a content area. The content may be received at server 180 from content server 196 when the content is requested at client computing device 190. For example, content may be requested from content server 196 via a content area (e.g., browser tab) of a browser or application executing at client computing device 190. Content server 196 may provide the content to server 180. A content area or application from where a content request is made (or where content is received or pushed) can be, for example, associated with an account linked to a first social network. The content area may be associated with the account linked to the first social network when user 176 signs into the account via the content area. Similarly, an application may be associated with the account linked to the first social network when user 176 signs into the application via the application. The first social network may be associated with a first social endorsement type (or model) that may be represented via a first icon in association with the content.

Process 300 proceeds by automatically determining one or more social endorsement types to allow endorsement of the content, where the endorsement types may be determined based on one or more of: a second social network originally associated with the content or one or more other social networks linked to the account (block 304). As an example, social network determiner 134 may automatically determine one or more social endorsement types to allow endorsement of the content. The endorsement types can be determined based on one or more of: the second social network originally associated with the content or one or more other social networks linked to the account (e.g., account of user 176). For example, log-in credentials associated with a user account may also be shared or associated with other social networks. In some implementations, social network determiner 134 may determine the other social networks because they may share the same authentication information or authentication tokens. For example, if two different social networking accounts share the same authentication information or tokens, they may be determined by social network determiner 134 to be linked to same account.

The one or more determined social endorsement types can be provided, for display in the application, with the content (block 306). For example, endorsement engine 132 may provide one or more determined social endorsement types can be provided for display in the content area with the content. In this way, for example, even when the content is displayed at an application at client computing device 190 that is presently associated with an account linked to a first social network, endorsement engine 132 may automatically determine that second social endorsement type may need to be displayed with the content because the content was originally associated (e.g., published) with the second social network.

When one or more selections to endorse the content via the displayed one or more determined social endorsement types are received, the content can be endorsed at the second social network regardless of one or more selected social endorsement types (block 308). In this way, an original creator or publisher of the content may receive endorsements on the second social network where the creator initially anticipated receiving endorsements instead of (or in addition to) the first social network.

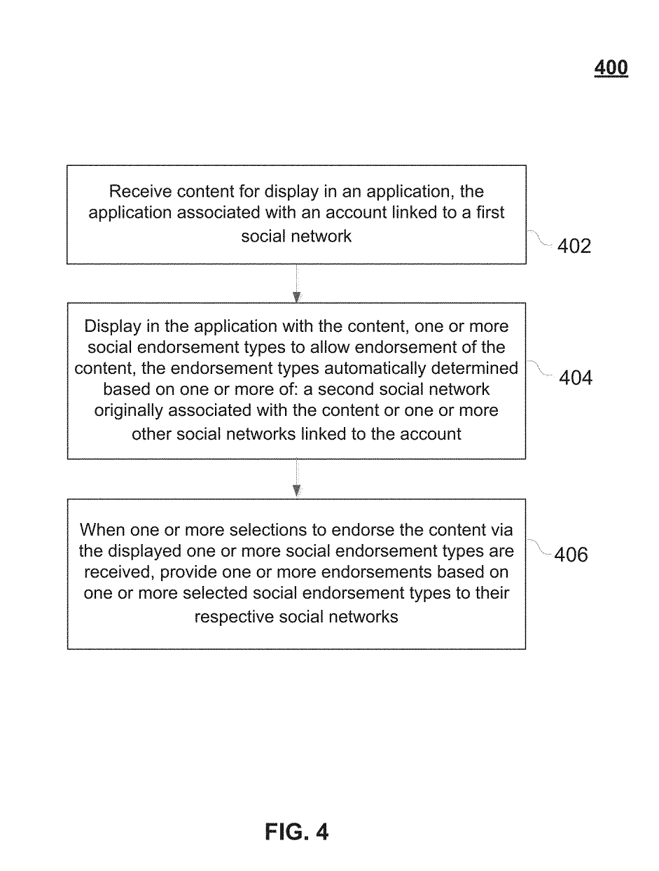

FIG. 4 is an example process 400 for practicing implementations of the subject technology using the example device of FIG. 1A. Although FIG. 4 is described with reference to the elements of FIG. 1A, the process of FIG. 4 is not limited to such and can be applied within other systems.

Process 400 begins with receiving content for display in an application, where the application can be associated with an account linked to a first social network (step 402). For example, client computing device 190 may receive content for display in a content area. The content may be received from server 180 when the content is requested at client computing device 190. For example, content may be requested from content server 196 via a content area (e.g., browser tab) of a browser or application executing at client computing device 190. Content server 196 may provide the content to server 180 from where the content may be provided to client computing device 190 in accordance with the disclosed implementations. A content area or application from where a content request is made (or where content is received or pushed) can be, for example, associated with an account linked to a first social network. The content area may be associated with the account linked to the first social network when user 176 signs into the account via the content area. Similarly, an application may be associated with the account linked to the first social network when user 176 signs into the application via the application. The first social network may be associated with a first social endorsement type (or model) that may be represented via a first icon in association with the content.

Process 400 proceeds by displaying in the application with the content, one or more social endorsement types to allow endorsement of the content, where the endorsement types may be automatically determined based on one or more of: a second social network originally associated with the content or one or more other social networks linked to the account (block 404). As an example, social network determiner 134 may automatically determine one or more social endorsement types to allow endorsement of the content. The endorsement types can be determined based on one or more of: the second social network originally associated with the content or one or more other social networks linked to the account (e.g., account of user 176). For example, log-in credentials associated with a user account may also be shared or associated with other social networks. In some implementations, social network determiner 134 may determine the other social networks because they may share the same authentication information or authentication tokens. For example, if two different social networking accounts share the same authentication information or tokens, they may be determined by social network determiner 134 to be linked to same account.

When one or more selections to endorse the content via the displayed one or more social endorsement types are received, one or more endorsements based on one or more selected social endorsement types can be provided to their respective social networks (step 406).

Returning to FIG. 1A, in certain aspects, server 180 may be implemented using hardware or a combination of software and hardware, either in a dedicated server, or integrated into another entity, or distributed across multiple entities.

Server 180 includes a bus 124 or other communication mechanism for communicating information, and processor 112 coupled with bus 124 for processing information. Processor 112 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Server 180 can include, in addition to hardware, code that creates an execution environment for the computer program in question, e.g., code that constitutes processor firmware, a protocol stack, a database management system, an operating system, or a combination of one or more of them stored in memory 120. Memory 120 may include Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 124 for storing information and instructions to be executed by processor 112. The processor 112 and the memory 120 can be supplemented by, or incorporated in, special purpose logic circuitry.

The instructions may be stored in the memory 120 and implemented in one or more computer program products, i.e., one or more modules of computer program instructions encoded on a computer readable medium for execution by, or to control the operation of, the server 180, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 120 may also be used for storing temporary variable or other intermediate information during execution of instructions to be executed by processor 112.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Server 180 further includes a data storage device 126 such as a magnetic disk or optical disk, coupled to bus 124 for storing information and instructions. Server 180 may be coupled via input/output module 128 to various devices. The input/output module 128 can be any input/output module. Example input/output modules 128 include data ports such as USB ports. The input/output module 128 is configured to connect to a communications module 118. Example communications modules 118 (e.g., communications module 118 and 238) include networking interface cards, such as Ethernet cards and modems. In certain aspects, the input/output module 128 is configured to connect to a plurality of devices, such as an input device 116 and/or an output device 114. Example input devices 114 include a keyboard and a pointing device, e.g., a mouse or a trackball, by which a user can provide input to the server 180. Other kinds of input devices 114 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 116 include display devices, such as a LED (light emitting diode), CRT (cathode ray tube), or LCD (liquid crystal display) screen, for displaying information to the user.

According to one aspect of the present disclosure, server 180 can be implemented using a server 180 in response to processor 112 executing one or more sequences of one or more instructions contained in memory 120. Such instructions may be read into memory 120 from another machine-readable medium, such as data storage device 126. Execution of the sequences of instructions contained in main memory 120 causes processor 112 to perform the process blocks described herein. One or more processors in a multi-processing arrangement may also be employed to execute the sequences of instructions contained in memory 120. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Server 180 can be, for example, and without limitation, a desktop computer, laptop computer, or tablet computer. Server 180 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions or data to processor 112 for execution. Such a medium may take many forms, including, but not limited to, non-volatile media and volatile media. Non-volatile media include, for example, optical disks, magnetic disks, or flash memory, such as data storage device 126. Volatile media include dynamic memory, such as memory 120. Transmission media include coaxial cables, copper wire, and fiber optics, including the wires that comprise bus 124. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate aspects can also be implemented in combination in a single aspect. Conversely, various features that are described in the context of a single aspects can also be implemented in multiple aspects separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

These and other implementations are within the scope of the following claims.

1. A method comprising:
receiving, by a first server associated with a first social network, content for display in a content area, the content area associated with an account linked to the first social network, the content being received from a second server different than the first server;
reading, by the first server based on receiving the content from the second server, data associated with the content at the first server, the data including an identification of a second social network that published the content and available endorsement types for the content at the second social network, the second social network being different than the first social network;
automatically determining, by the first server in response to receiving the content from the second server and reading the data, one or more visually displayable social endorsement types based on the available endorsement types for the content at the second social network identified in the read data, the one or more visually displayable social endorsement types configured to endorse the content at the second social network;
generating, by the first server for display in the content area with the content, responsive to reading the data and automatically determining the one or more-visually displayable social endorsement types, respective representations of the one or more determined social endorsement types;
receiving, by the first server, a selection to endorse the content via a selected representation of the respective representations; and
in response to receiving the selection, providing an endorsement of the content to the second social network using a selected social endorsement type provided by the second server and corresponding to the selected representation.

2. The method of claim 1, wherein the content is first published on the second social network.

3. The method of claim 1, wherein the automatically determining is performed by parsing markup language associated with the content.

4. The method of claim 1, further comprising:
determining the second social network is linked to the account based on one or more of: previous endorsements provided at the second social network or open authentication information associated with the account.

5. The method of claim 1, wherein the one or more determined social endorsement types are provided for display in a widget associated with the content.

6. The method of claim 1, wherein the content area is at least one of a browser tab or an application interface.

7. The method of claim 1, wherein the content includes one or more of: video content, audio content or text content.

8. A non-transitory machine-readable medium comprising instructions stored therein, which when executed by a processor, causes the processor to perform operations comprising:
receiving, by a first server associated with a first social network, content for display in an application, the application associated with an account linked to the first social network, the content being received from a second server different than the first server;
reading, by the first server based on receiving the content from the second server, data associated with the content at the first server, the data including an identification of a second social network that published the content and available endorsement types for the content at the second social network, the second social network being different than the first social network;
automatically determining, by the first server in response to receiving the content from the second server and reading the data, one or more visually displayable social endorsement types based on the available endorsement types for the content at the second social network identified in the read data, the visually displayable social endorsement types configured to endorse the content at the second social network;
generating, by the first server for display in the application with the content responsive to reading the data and automatically determining the one or more visually displayable social endorsement types, respective representations of the one or more determined social endorsement types;
receiving, by the first server, a selection to endorse the content via a selected representation of the respective representations; and
in response to receiving the selection, providing an endorsement of the content to the second social network using a selected social endorsement type provided by the second server and corresponding to the selected representation.

9. The non-transitory machine-readable medium of claim 8, wherein the content is first published on the second social network.

10. The non-transitory machine-readable medium of claim 8, wherein the automatically determining is performed by parsing markup language associated with the content.

11. The non-transitory machine-readable medium of claim 8, further comprising:
determining the second social network is linked to the account based on one or more of: previous endorsements provided at the second social network or open authentication information associated with the account.

12. The non-transitory machine-readable medium of claim 8, wherein the one or more determined social endorsement types are provided for display in a widget associated with the content.

13. The non-transitory machine-readable medium of claim 8, wherein the application is instantiated on a mobile device.

14. The non-transitory machine-readable medium of claim 8, wherein the content includes one or more of: video content, audio content or text content displayed in the application.

15. A system comprising:
a non-transitory memory medium comprising instructions stored thereon; and
a processor device configured to execute the instructions to:
receive content for display in an application, the application associated with an account linked to a first social network, the content being received from a server remote from the system;
reading, based on receiving the content from the server, data associated with the content at the system, the data including an identification of a second social network that published the content and available endorsement types for the content at the second social network, the second social network being different than the first social network;
automatically determining, in response to receiving the content from the server and reading the data associated with the content, one or more visually displayable social endorsement types provided by the server based on the available endorsement types for the content at the second social network identified in the read data, the one or more visually displayable social endorsement types configured to endorse the content at the second social network;
generating for display in the application with the content responsive to reading the data and automatically determining the one or more visually displayable social endorsement types, respective endorsement controls of the one or more social endorsement types;
receiving a selection to endorse the content via a selected endorsement control of the respective endorsement controls; and
in response to receiving the selection, provide an endorsement of the content to the second social network using an endorsement type provided by the server and corresponding to the selected endorsement control.

16. The system of claim 15, wherein the content is first published on the second social network.

17. The system of claim 15, wherein the application is instantiated on a mobile device.

18. The system of claim 15, wherein the one or more determined social endorsement types are displayed in a widget associated with the content.

19. The system of claim 15, wherein the endorsement types are determined by parsing markup language associated with the content.

20. The system of claim 15, wherein the second social network is determined to be linked to the account based on one or more of: previous endorsements provided at the second social network or open authentication information associated with the account.
